(19) United States
(12) Patent Application Publication
(10) Pub. No.: US 2014/0167919 A1
(43) Pub. Date: Jun. 19, 2014

(54) COLLAPSIBLE STORAGE RACK WITH INTEGRAL RFID TAG SCANNER

(71) Applicants: Interstate Battery System International, Inc., Dallas, TX (US); Seeonic, Inc., Plymouth, MN (US)

(72) Inventors: Nicholas Singh, Apple Valley, MN (US); Bruce Hellen, Woodinville, WA (US)

(73) Assignees: Interstate Battery System International, Inc., Dallas, TX (US); Seeonic, Inc., Plymouth, MN (US)

(21) Appl. No.: 14/040,474

(22) Filed: Sep. 27, 2013

Related U.S. Application Data
(60) Provisional application No. 61/706,514, filed on Sep. 27, 2012.

(51) Int. Cl. A47F 5/10; G06K 7/10

(52) U.S. Cl. CPC A47F 5/10; G06K 7/10366
USPC 340/10.1; 211/149

(57) ABSTRACT

A collapsible storage rack includes an integral RFID tag scanner configured to read RFID tags of products stored thereon. The storage rack is adjustable between an expanded configuration and a collapsed configuration.

### CROSS REFERENCE TO RELATED APPLICATION

This application claims priority to U.S. Provisional Application Ser. No. 61/706,514 filed on Sep. 27, 2012, entitled COLLAPSIBLE STORAGE RACK WITH INTEGRAL RFID TAG SCANNER, the disclosure of which is incorporated by reference herein in its entirety.

### BACKGROUND

Product inventory is often tracked in retail and other environments using point of sale or similar systems. Unfortunately, such systems often have a high error when inventory data is compared to the actual inventory of products within the retail store. As a result, inventory often must be checked manually, by physically counting products on the shelves, or by using handheld barcode readers or handheld radio frequency identification (RFID) tag scanners. A major drawback to using such handheld devices is the manual labor required. As a result, such manual inventory processes are typically conducted infrequently, such that actual product inventory at any given time is often uncertain.

### SUMMARY

In general terms, this disclosure is directed to a collapsible storage rack with integral RFID tag scanner.

One aspect is a collapsible storage rack comprising: one or more shelves including one or more antennas configured to communicate with RFID tags; a frame structure including side panels and a back panel, wherein the one or more shelves are pivotally connected to the back panel, and wherein the side panels include shelf supports for removable attachment of the one or more shelves to the side panels; a control unit including RFID tag scanning circuitry configured to send and receive RF signals using the antennas; wherein the collapsible storage rack is adjustable between an expanded configuration and a collapsed configuration.

Another aspect is a method of expanding a collapsible storage rack, the method comprising: rotating side panels of a frame structure with respect to a back panel at pivot joints between the side panels and the back panels until the side panels are substantially perpendicular to the back panel; rotating shelves coupled to the back panel from a collapsed configuration to an expanded configuration by rotating the shelves about pivot joints between the shelves and the back panel, wherein at least some of the shelves include one or more antennas therein; engaging the shelves with the side panels to support the side panels in the expanded configuration; and activating a control unit containing RFID tag scanning electronics configured to send and receive RF signals using the antennas.

### BRIEF DESCRIPTION OF THE DRAWINGS

FIG. 1 is an upper perspective view of the storage rack in an expanded configuration.

FIG. 2 is a lower perspective view of the storage rack shown in FIG. 1.

FIG. 3 is a front view of the storage rack shown in FIG. 1.

FIG. 4 is a side view of the storage rack shown in FIG. 1.

FIG. 5 is a rear view of the storage rack shown in FIG. 1.

FIG. 6 is a perspective view of the storage rack in a collapsed configuration.

FIG. 7 is a front view of the storage rack shown in FIG. 6.

FIG. 8 is a side view of the storage rack shown in FIG. 6.

FIG. 9 is a rear view of the storage rack shown in FIG. 6.

FIG. 10 is a perspective view of an example shelf of the storage rack shown in FIG. 1.

FIG. 11 is a schematic block diagram of the shelf shown in FIG. 10.

FIG. 12 is a schematic block diagram of an example control unit of the shelf shown in FIG. 1.

FIG. 13 is another example of the storage rack, storing products thereon.

### DETAILED DESCRIPTION

Various embodiments will be described in detail with reference to the drawings, wherein like reference numerals represent like parts and assemblies throughout the several views. Reference to various embodiments does not limit the scope of the claims attached hereto. Additionally, any examples set forth in this specification are not intended to be limiting and merely set forth some of the many possible embodiments for the appended claims.

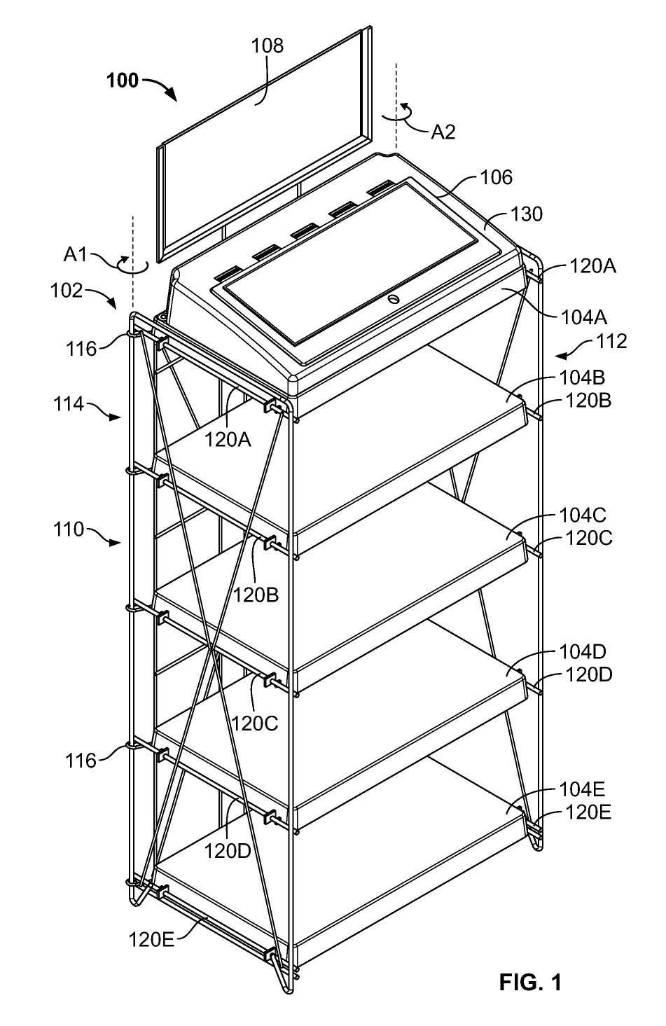

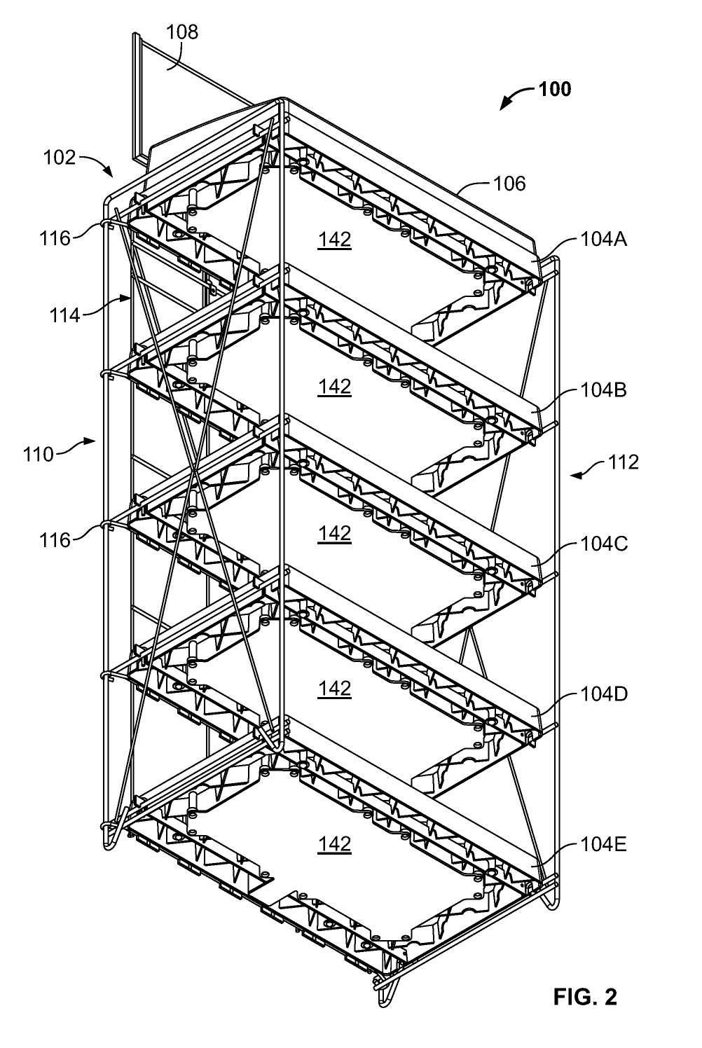

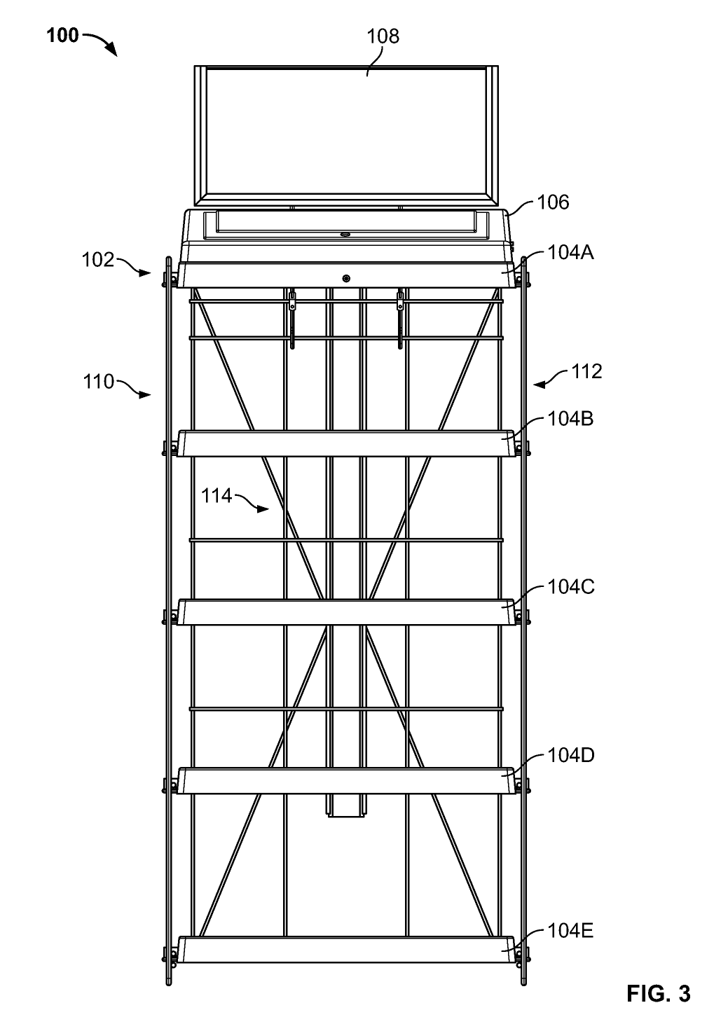

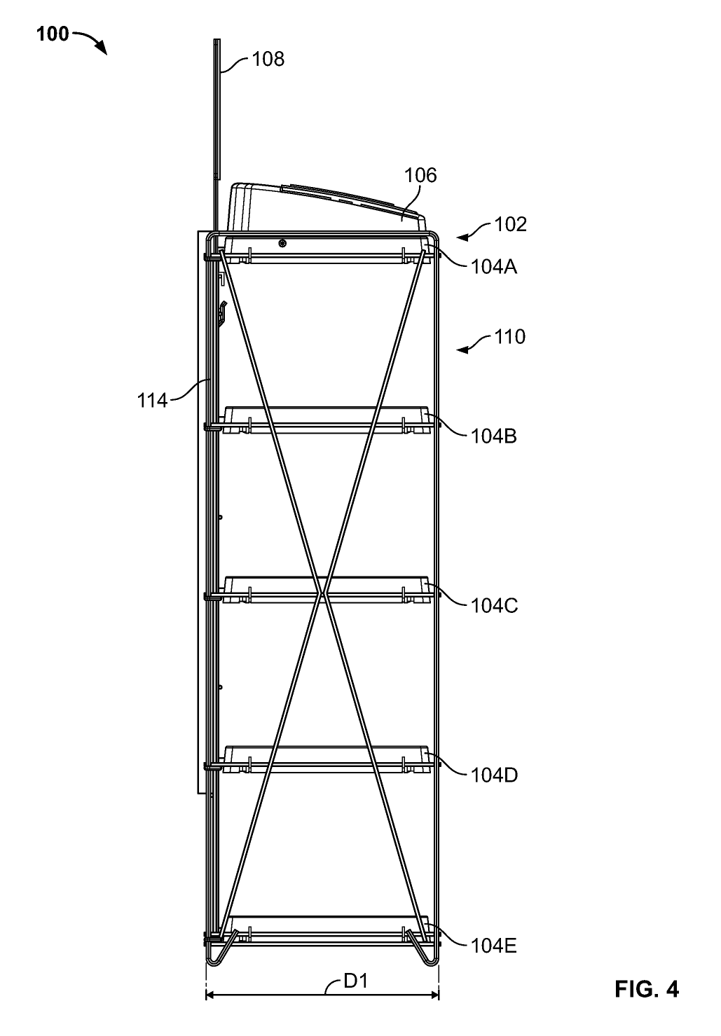

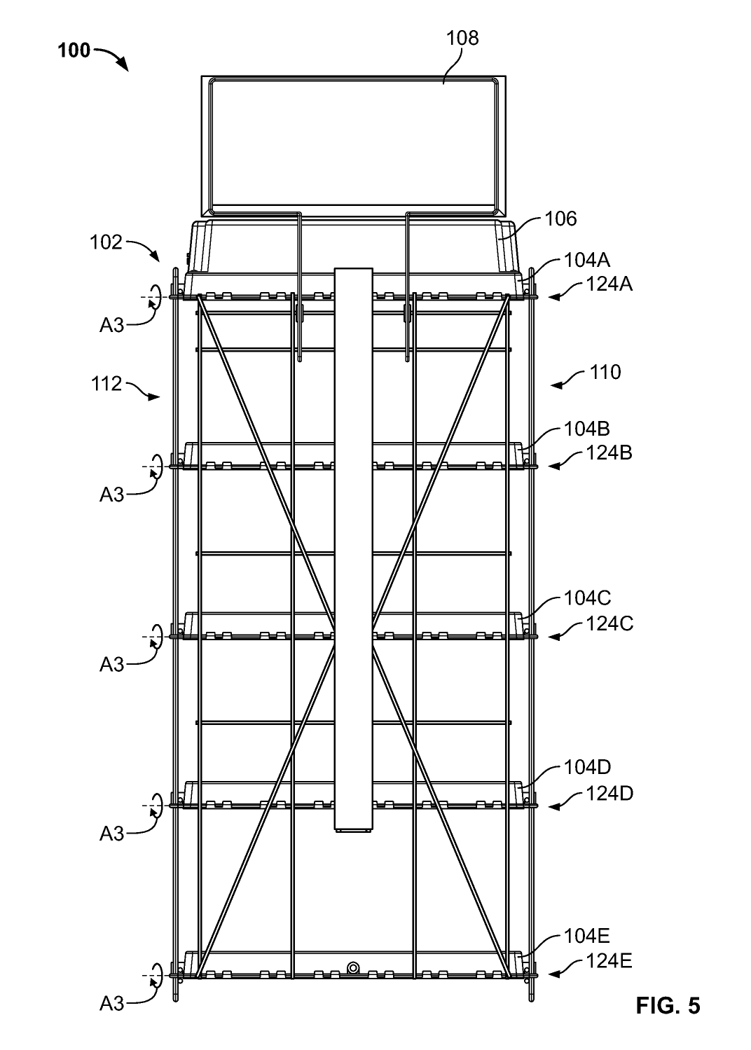

FIGS. 1-9 illustrate an example of the collapsible storage rack 100. FIGS. 1-5 illustrate the collapsible storage rack 100 in an expanded configuration. More specifically, FIG. 1 is an upper perspective view, FIG. 2 is a lower perspective view, FIG. 3 is a front view, FIG. 4 is a side view, and FIG. 5 is a rear view.

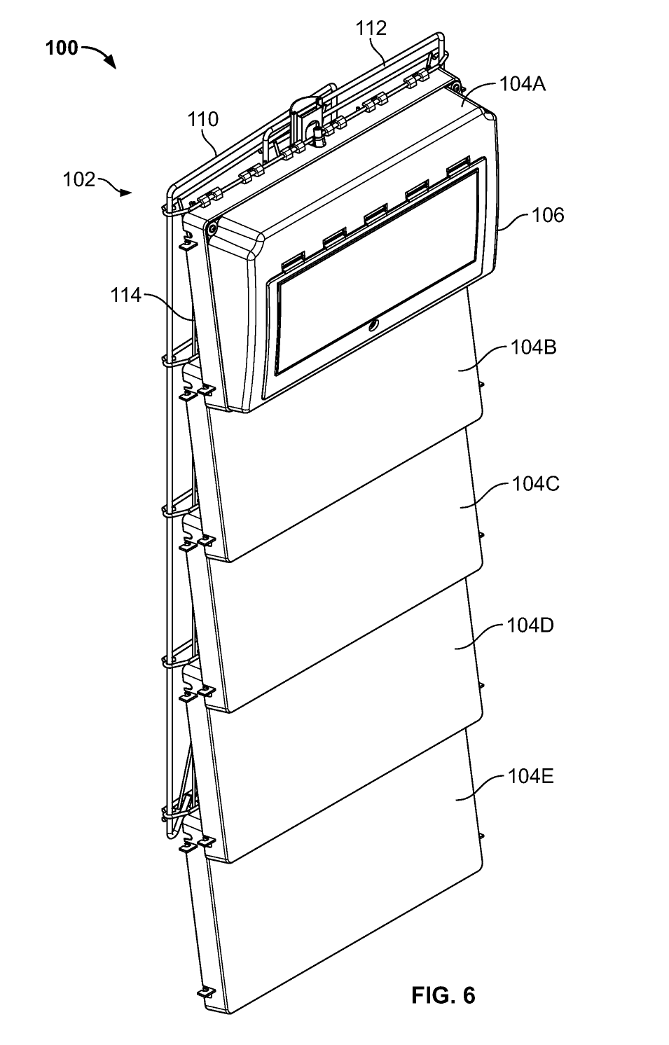

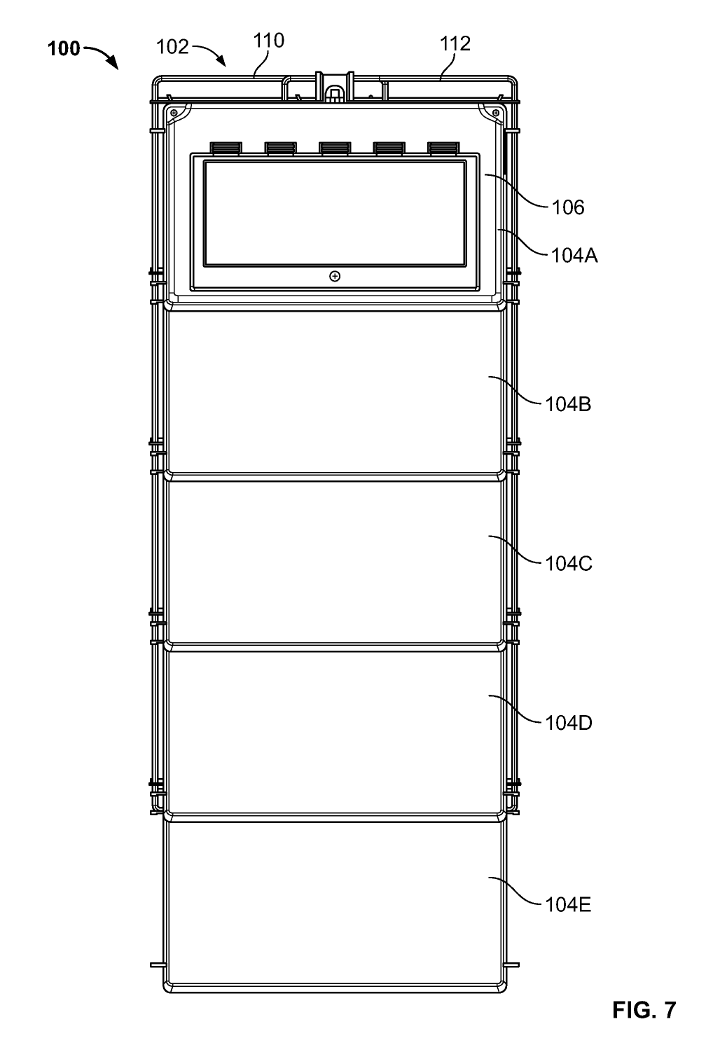

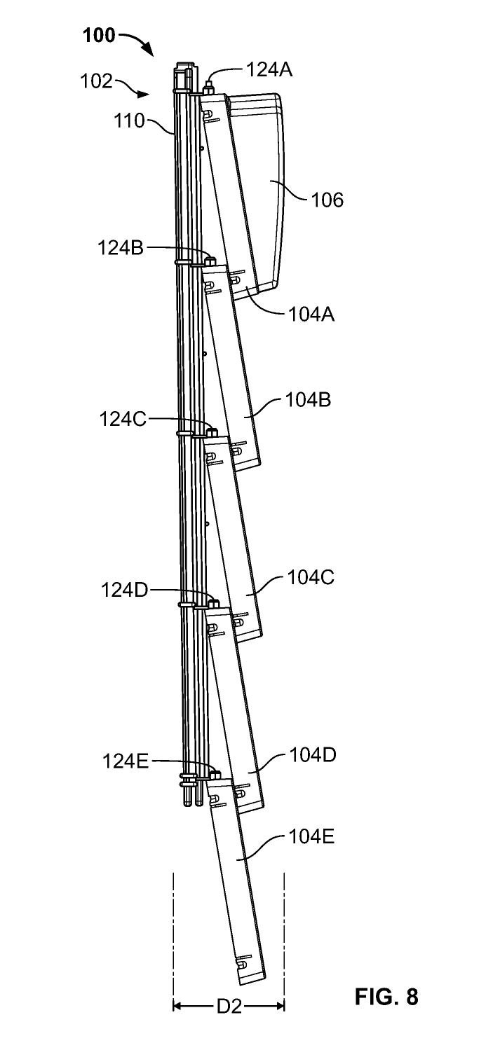

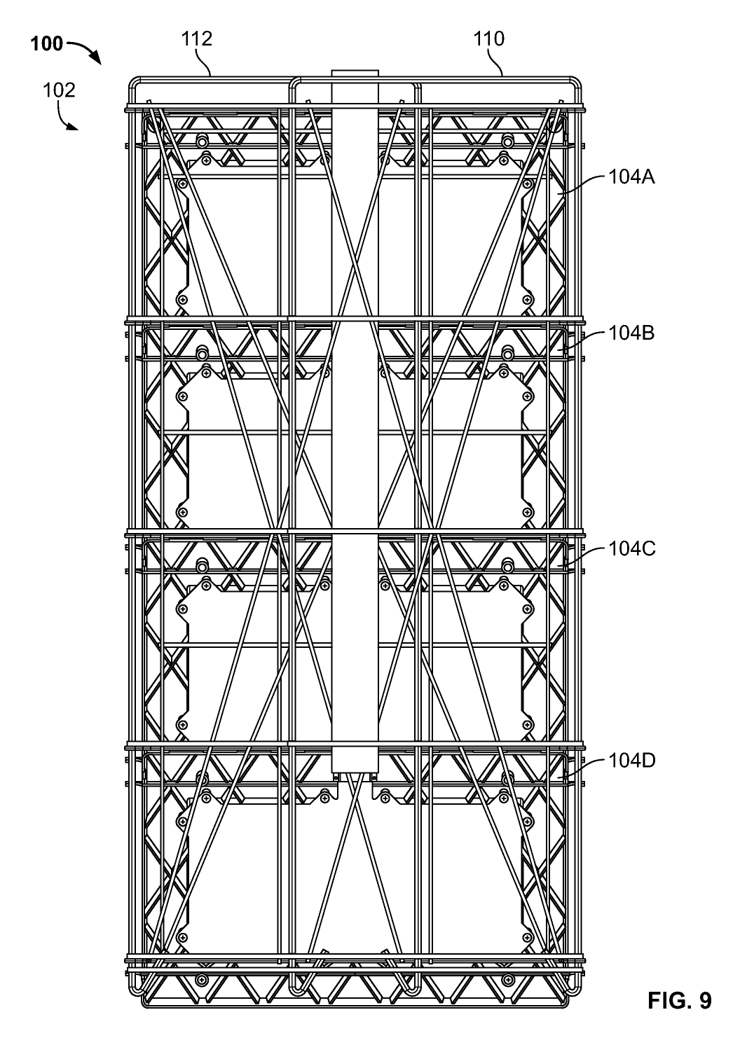

FIGS. 6-9 illustrate the collapsible storage rack 100 in a collapsed configuration. More specifically, FIG. 6 is a perspective view, FIG. 7 is a front view, FIG. 8 is a side view, and FIG. 9 is a rear view.

Referring to FIG. 1, in this example, the storage rack 100 includes a frame 102, shelves 104 (including shelves 104A-E, for example), and a control unit 106. This example also includes a display panel 108, which can be included in some embodiments.

In some embodiments, the frame 102 is formed of wire bent into the appropriate configuration. The thickness of the wire is selected to provide the desired strength and rigidity. Other embodiments are made of other materials, such as wood, plastic, and the like. In some embodiments the frame 102 is covered or enclosed by another material.

In this example, the frame 102 includes side panels 110 and 112, and a back panel 114. In some embodiments, the side panels 110 and 112 are constituted to function as support panels to support the shelves 104 on the frame 102. The side panels 110 and 112 are connected to the back panel 114 at a pivot joint 116, which permits the side panels to rotate with respect to the back panel in the directions A1 and A2, shown in FIG. 1. In other embodiments, other support panels are provided to support the shelves in an expanded configuration. For example, a front panel can be configured to function as a support panel. In yet another embodiment, one or more separate support panels are provided in addition to or in place of side, rear, and/or front panels.

The side panels 110 and 112 include shelf supports 120 (including shelf supports 120A-E). The shelf supports 120 are positioned to support the shelves 104A-E, respectively, when the storage rack 100 is in the expanded configuration. In another embodiment, the support panels can be made as separate panels and used, instead of, or along with, the side panels 110 and 112, to support the shelves 104A-E, respectively, when the storage rack 100 is in the expanded configuration. For example, the support panels can be removably attached to any part of the frame, such as the side, front, or back of the frame, to support the shelves on the frame. In other embodiment, the back panel can be constituted to work as the support panel.

The back panel similarly includes shelf supports 122 (including shelf supports 122A-E). The shelf supports 122 are connected to the respective shelves 104A-E at a pivot joint 124 (including pivot joints 124A-E), best shown in FIG. 5. The pivot joints 124 permit the shelves 104 to rotate with respect to the back panel 114, to pivot about the shelf supports 122 in the direction A3 and the direction opposite A3 (FIG. 5).

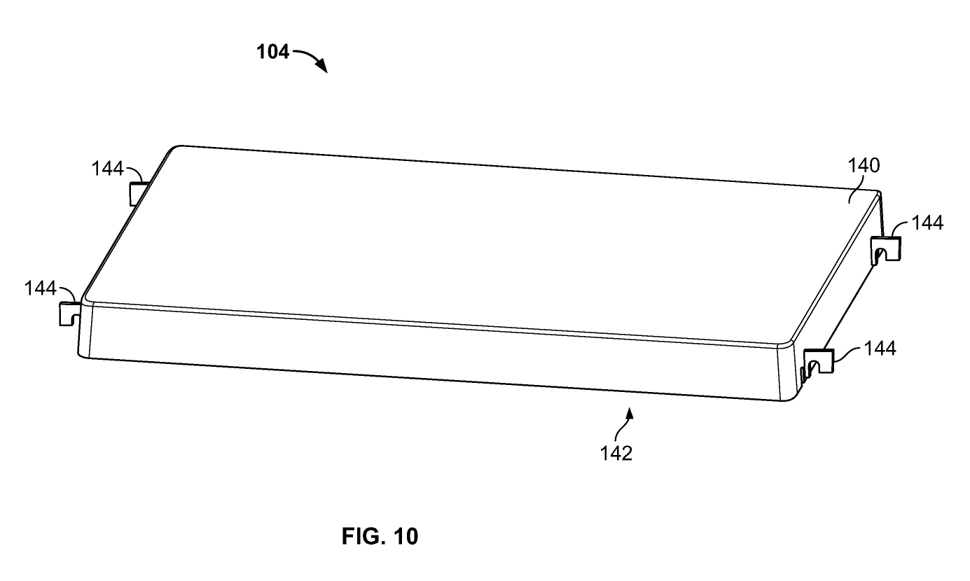

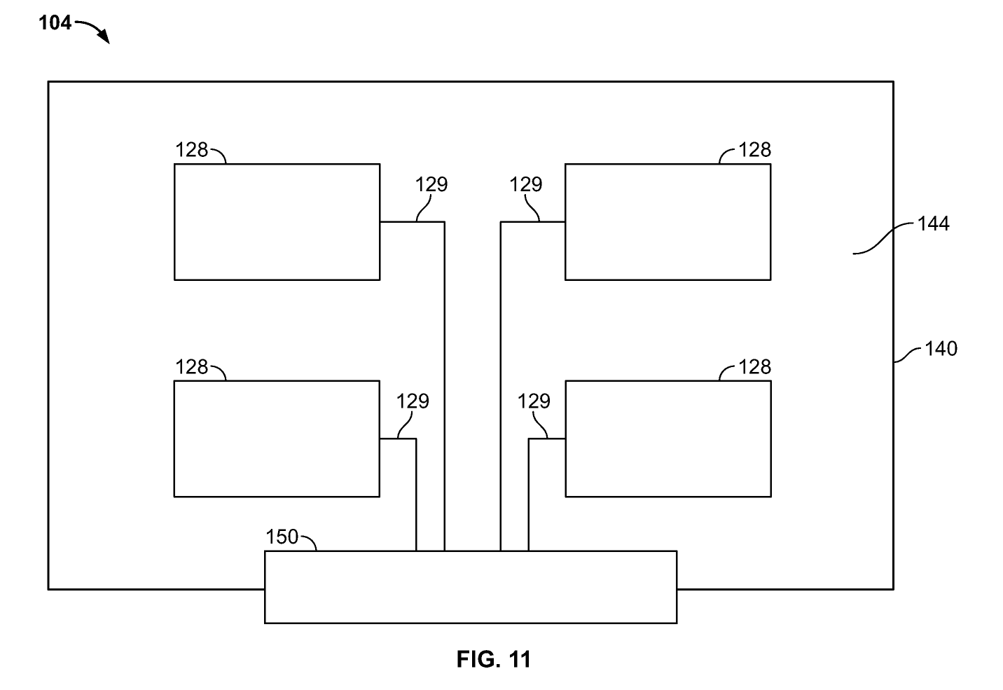

The shelves 104 are configured to support products thereon, such as to display the products in a retail environment to potential customers. At least some of the shelves 104 include one or more antennas 128 contained within an interior compartment of the shelves 104. For example, the antennas 128 may be included within shelves 104A-D, but not within shelf 104E in some embodiments. Although any number of antennas 128 may be included within a shelf 104, some embodiments include four antennas therein. An example of a shelf 104 is illustrated and described in more detail herein with reference to FIGS. 10-11.

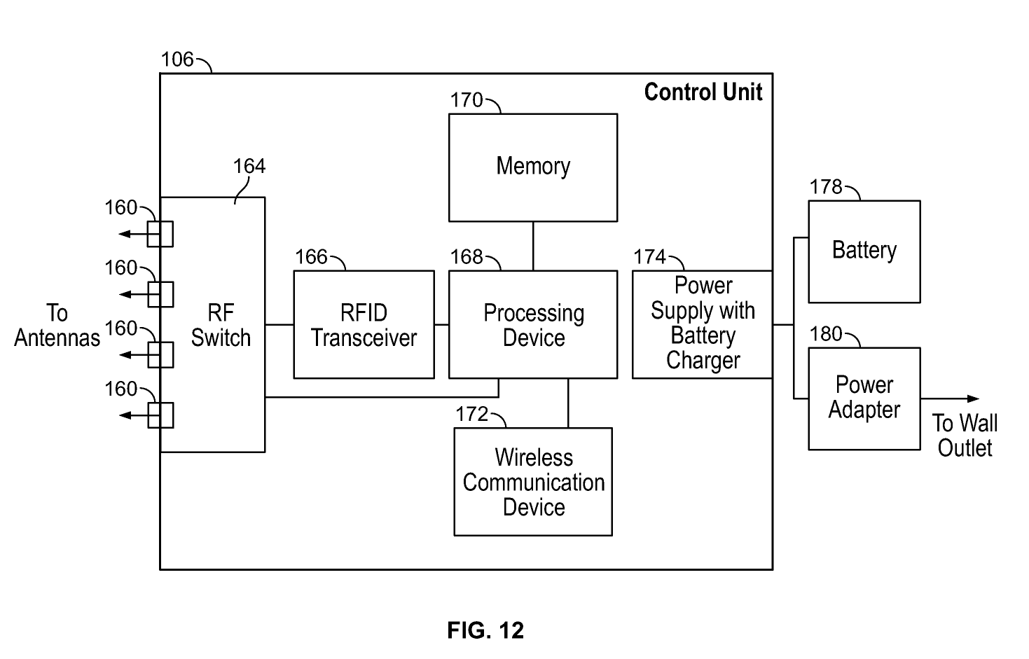

In some embodiments, the uppermost shelf 104A supports the control unit 106. The control unit 106 includes RFID tag scanning circuitry, for example, and is contained within a housing 130. The upper surface of the housing 130 is has a tapered non-flat shape to deter people from utilizing the housing 130 as an additional storage surface. An example of the control unit 106 is illustrated and described in more detail herein with reference to FIG. 12.

RF transmission lines (not shown in FIGS. 1-9) can be used to transmit RF signals between the control unit 106 and the antennas 128 within the shelves 104. The RF transmission lines can be permanently connected or removable.

The storage rack 100 is configured to be easily adjustable between the expanded and collapsed positions. When in the collapsed position, the overall volume of space consumed by the storage rack 100 is reduced. As a result, the storage rack 100 can be stored more compactly, for example. Additionally, the shipping size is reduced, making the storage rack 100 easier to handle, reducing the amount of packaging required, and possibly reducing shipping costs.

Referring to FIG. 4, the storage rack 100 has a depth Dl when the storage rack 100 is in the expanded configuration. As one example, the depth Dl is about 8.6 inches.

Referring now to FIG. 8, the storage rack 100 has a depth D2 when the storage rack is in the collapsed configuration. As one example, the depth D2 is about 20 inches. Accordingly, in some embodiments the depth D2 is less than about half of the depth Dl. In another embodiment, the depth D2 is less than about 20% of the depth Dl. In other possible embodiments, the depth D2 is less than about 80%, 75%, 60%, 40%, 25% of D1.

In some embodiments, the storage rack 100 can be easily assembled from the collapsed configuration to the expanded configuration. One example is as follows. Beginning from the collapsed configuration shown in FIGS. 6-9, the side panels 110 and 112 are first rotated opposite the directions A1 and A2 (FIG. 1) until the side panels 110 and 112 are nearly perpendicular to the back panel 114. Next, starting at either the top or the bottom, the shelves 104 are rotated in the direction opposite A2 (FIG. 5) and engaged with the respective shelf supports 120. The process is repeated for each shelf in order. Flexibility in the side panels 110 permits them to slightly bend so that subsequent shelves 104 can be engaged without disengaging previously engaged shelves 104. If necessary, cables can then be connected between the control unit 106 and the antennas 128.

This assembly process can be completed very quickly, such as in less than one minute, or in less than five minutes.

The storage rack 100 can be similarly collapsed by reversing the assembly steps discussed above.

FIG. 10 is a perspective view of an example shelf 104. The shelf includes a body 140, a removable panel 142, an interior space 144, and side panel clips 146.

The body 140 is a rigid member sized and shaped to extend between the side panels 110 and 112 (FIG. 1) and between the back panel 114 and the front of the storage rack 100. The body 140 typically has a flat upper surface configured to support products thereon. The body 140 can be formed of material such as plastic, wood, or metal, for example. Plastic is preferred to reduce any possible interference with the RF signals.

As best seen in FIG. 2, the body can include a removable panel 142, which provides access to an interior space between the removable panel 142 and the body 140. The interior space is provided to house antennas 128 therein.

FIG. 10 also shows side panel clips 146, which extend from ends of the shelf 104, and are configured to engage with shelf supports 120 shown in FIG. 1 to support the shelf in a substantially horizontal orientation when in the extended configuration, such that products can be supported on the upper surface of the body 140.

FIG. 11 is a schematic block diagram of an example shelf 104, illustrating the antennas 128 that can be contained within the interior space 144. The antennas 128 are of a type suitable for emitting and receiving RF signals to receive product identification information from RFID tags on products, when the products are stored on the storage rack 100.

As shown in FIG. 11, the antennas are typically arranged in a common plane, and spaced from each other. The spacing and arrangement of the antennas permits RF signals to be generated at different locations about the respective shelf 104. This greatly reduces the chance of non-detection of an RFID tag, by permitting the control unit 106 to attempt to detect the RFID tag from multiple locations using different antennas 128.

A variety of possible antennas 128 can be used, provided that the antennas 128 are suitable for communicating with the RFID tags. As one example, the antenna may have one or more of the following characteristics: dimensions of approximately 6″ by 6″ by 3/16″; a FR4 substrate; a center frequency of about 915 MHz; the ability to read EPC Class 1 Gen 2 Standard RFID tags; a bandwidth of about 80 MHz; a voltage standing wave ratio (VSWR) of about −25 dB; and circularly polarized. An example of antenna 128 is the Eye antenna available from Seeonic, Inc., Plymouth, Minn. Other embodiments have antennas 128 with other characteristics.

Antenna cables 129, or other transmission lines, are connected to each of the antennas 128. The antenna cables 129 can terminate in an RF connector or RF switch 150, in different embodiments. An RF transmission line (not shown in FIG. 11) is then used to connect the antennas 128 of shelf 104 to the control unit 106. In other embodiments, the antenna cables 129 can be hardwired directly to the control unit 106 through an RF transmission line without such an interface as the RF connector or RF switch 150.

FIG. 12 is a schematic block diagram of an example of the control unit 106. In this example, the control unit 106 includes RF connectors 160, RF switch 164, RFID transceiver 166, processing device 168, memory 170, wireless communication device 172, power supply 174, and housing 130. Also illustrated in FIG. 12 is a battery 178 and power adapter 180, which can be included within or exterior to the housing 130 in various embodiments. An example of the control unit 106 is the SightWare device available from Seeonic, Inc., in Plymouth, Minn. As an example of the RF switch 144, the WideVision switch can be used, which is available from Seeonic, Inc. in Plymouth, Minn.

The RF connectors 160 are configured to be connected to RF transmission lines to communicate with the antennas 128 of shelves 104. In some embodiments the RF connectors 160 permit removable attachment of the RF transmission lines to the control unit 106. In other embodiments, the RF transmission lines are permanently connected to the control unit 106. An example of an RF connector 160 is a coaxial cable connector. The conductors of the RF connectors 160 are electrically coupled to the RF switch 164.

In some embodiments, the RF connectors 160 and RF transmission lines (or one or both ends thereof) are color coded to ensure proper connection of the cables with the appropriate connectors.

The RF switch 164 is electrically coupled to the RF connectors 160 to communicate RF signals to and from the antennas 128 contained within the shelves 104 (FIG. 11). The RF switch 164 is controlled by the processing device 168, which operates in some embodiments to select one of the antennas 128 (or antenna shelves 104) for communication at a given time. The RF switch 164 is also connected to the RFID transceiver 166 by an RF transmission line suitable for transmitting the RF signals therebetween.

The RFID transceiver 166 operates under the control of the processing device 168 to generate and transmit RF signals across the RF transmission lines to a selected antenna 128 (FIG. 11), and also to receive return RF signals from the RFID tags. An example of the RFID transceiver 166 is the R2000 chip set from Impinj of Seattle, Wash.

The processing device 168 controls the overall operation of the control unit 106. The processing device 168 can be any processing device operable to execute program instructions, such as a microprocessor or microcontroller. A specific example of the processing device 168 is a 32-bit PIC microcontroller available from Microchip Technologies Inc. of Chandler, Ariz.

The control unit 106 also includes a memory device 170, which may be part of the processing device 168 or separate from the processing device 168. An example of the memory device 170 is Random Access Memory (RAM), such as 16 Mbye DRAM available from Micron Technology, Inc. of Boise, Id. Other computer readable storage devices are used in other embodiments. Computer readable storage devices do not include communication media, such as transitory media that conduct signals on communication lines and cables.

In some embodiments, the control unit 106 includes a wireless communication device 172, which is electrically coupled to (or at least in data communication with) and controlled by the processing device 168. In some embodiments, the wireless communication device 172 is a cellular communication device, suitable for communicating data across a cellular communication network. Examples of the wireless communication device 172 include the PHS8 (for GSM) and the PVS8 (for CDMA) communication modules available from Cinterion Wireless Modules GmbH of Munich Germany.

The power supply 174 provides power to the various components of the control unit 106. In some embodiments, the power supply 174 includes a battery charger that operates to charge the battery 178 when connected to an external power source, such as through the power adapter 180. An example of the battery charger is the

LTC2950IDDB-2#TRMPBF-IC, Push Button On/Off Controller power supply available from Linear Technology, Inc. of Milpitas, Calif.

The battery 178 can be included within or external to the housing 130. An example of a battery is a 12V sealed lead acid battery. Other embodiments utilize other batteries. The battery is coupled to the power supply 174 to provide power to the control unit 106 and for recharging when the power supply 174 is connected to an external power source, such as a wall outlet. Examples of the power supply 174 are the SLA1115 Sealed Lead Acid Battery and the BSL 1075 Sealed Lead Acid Battery from Interstate Batteries.

A power adapter 180 is provided in some embodiments to permit the control unit 106 to be connected to the external power source. The power adapter typically includes an AC to DC converter, which converts the external power to a desired DC power, such as 12V DC.

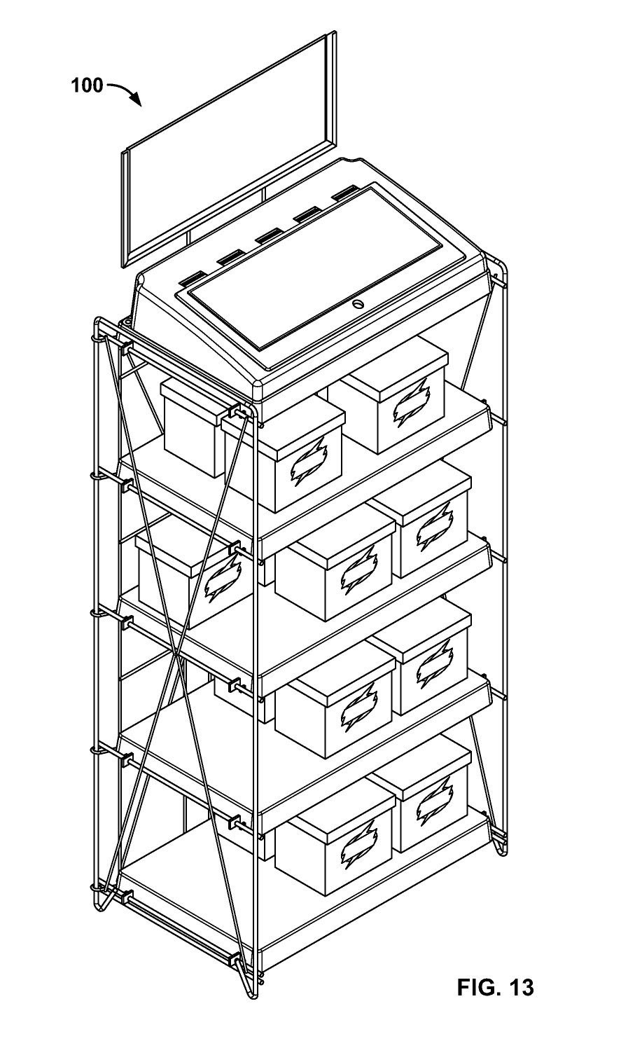

FIG. 13 illustrates another example of the collapsible storage rack 100 in an expanded configuration and storing products thereon. In this example, the collapsible storage rack 100 is a battery storage rack, which stores batteries, such as marine or automotive type lead acid batteries.

The various embodiments described above are provided by way of illustration only and should not be construed to limit the claims attached hereto. Those skilled in the art will readily recognize various modifications and changes that may be made without following the example embodiments and applications illustrated and described herein, and without departing from the true spirit and scope of the following claims.

What is claimed is:

1. A collapsible storage rack comprising:
one or more shelves including one or more antennas configured to communicate with RFID tags;
a frame structure including support panels and a back panel, wherein the one or more shelves are pivotally connected to the back panel, and wherein the support panels are configured to support the one or more shelves in the expanded configuration ;
a control unit including RFID tag scanning circuitry configured to send and receive RF signals using the antennas;
wherein the collapsible storage rack is adjustable between an expanded configuration and a collapsed configuration.

2. A method of expanding a collapsible storage rack, the method comprising:
rotating shelves coupled to the back panel from a collapsed configuration to an expanded configuration by rotating the shelves about pivot joints between the shelves and the back panel, wherein at least some of the shelves include one or more antennas therein;
engaging the shelves with support panels to support the shelves in the expanded configuration; and
activating a control unit containing RFID tag scanning electronics configured to send and receive RF signals using the antennas.
